(19) United States
(12) Patent Application Publication
(10) Pub. No.: US 2018/0256434 A1
(43) Pub. Date: Sep. 13, 2018

(54) ACTUATOR AND BODY ASSISTANCE DEVICE

(71) Applicant: DAIYA INDUSTRY CO., LTD., Okayama-shi (JP)

(72) Inventors: Masao MATSUO, Okayama-shi (JP); Kazunori OGAWA, Okayama-shi (JP); Tomohiro IKEDA, Okayama-shi (JP)

(21) Appl. No.: 15/755,174

(22) PCT Filed: Aug. 25, 2016
(86) PCT No.: PCT/JP2016/074745

§ 371 Date: Feb. 26, 2018

(30) Foreign Application Priority Data
Aug. 31, 2015 (JP) 2015-170385

(51) Int. Cl. A61H 3/00; F15B 15/10

(52) U.S. Cl. CPC A61H 3/00; F15B 15/103; A61H 2205/108; A61H 2201/1652; A61H 2201/1238

(57) ABSTRACT

A McKibben type actuator capable of generating at least the same contraction force as that of the related art with an application of a pressure lower than that required for those in the related art is provided. In an McKibben type actuator 10 including an inner tube 11 configured to be expanded when being pressurized, and an outer sleeve 12 covering an outer peripheral surface of the inner tube 11 to limit an expansion of the inner tube 11, the outer sleeve 12 being configured to convert a radial expansion of the inner tube 11 to a longitudinal contraction of the inner tube 11, the inner tube 11 is formed of a resilient material having an expansion rate of at least 100%.

### TECHNICAL FIELD

The present disclosure relates to a McKibben type actuator and a body assisting apparatus configured to assist body motion by using the actuator.

### BACKGROUND

A body assisting apparatus to be worn on a body, which is designed to assist motions of body parts such as legs and hands, is in a stage of practical realization in the fields of medicine and nursing care, and has been in developed in recent years. The body assisting apparatus is normally provided with an actuator configured to be activated by an input of pressure or of electric power, for example. Various types of actuators are proposed, and a fluid-pressure type actuator to be driven by a fluid pressure is now widely prevalent. Among others, a McKibbenMcKibben type actuator is widely used (See Paragraph [0046] and FIG. 4A and FIG. 4B of Patent Literature 1, for example).

The McKibbenMcKibben type actuator is a fluid-pressure type actuator including an inner tube configured to be expanded when being supplied with a fluid and pressurized; and an outer sleeve covering an outer peripheral surface of the inner tube to limit the expansion of the inner tube. In the McKibbenMcKibben type actuator, the outer sleeve is configured to convert a radial expansion of the inner tube occurring when the inner tube is pressurized into a longitudinal contraction. In other words, the McKibbenMcKibben type actuator assumes a thin and long form when the inner tube is not pressurized, and a thick and short form when the inner tube is pressurized. The McKibbenMcKibben type actuator is capable of generating a large contraction force, and thus may be employed suitably when assisting a motion of relatively heavy portions of the body.

However, in order to cause the McKibbenMcKibben type actuator to generate a large contraction force, the inner tube needs to be pressurized to a relatively high pressure. Therefore, the McKibben type actuator has a drawback in that the inner tube is susceptible to breakage and thus has a short life. In addition, the body assisting apparatus using the McKibben type actuator requires a high-power pump or the like for supplying a fluid into the inner tube, and thus has a drawback that the pump or the like tends to be large. The McKibben type actuator also has drawbacks that an increase in contraction rate is difficult and motions having significant displacement are difficult to assist. In addition, the McKibben type actuator also has a drawback that a wearer of the body assisting apparatus often has a feeling of.

### CITATION LIST

### Patent Literature

Patent Literature 1: WO 2011/036906

### SUMMARY

In order to solve the above-described problems, it is an object of the present disclosure to provide a McKibben type actuator capable of generating at least the same contraction force as those of the related art with an application of a pressure lower than those required in the related art. It is another object of the present disclosure to provide the McKibben type actuator resistant to breakage of the inner tube and having a long life. It is a further object of the present disclosure to achieve a size reduction of a device such as a pump for pressurizing the inner tube (inner tube pressurizing means) in the McKibben type actuator. It is a still further object of the present disclosure to provide the McKibben type actuator providing a high contraction rate and an ability to assist a motion having significant displacement. It is still another object of the present disclosure to provide the McKibben type actuator which prevents a wearer from feeling too constrained when the actuator is used in a body assisting apparatus. It is also another object of the present disclosure to provide a body assisting apparatus using the actuator of the present disclosure.

The above-described problems are solved by providing an actuator including:

an inner tube configured to be expanded when being pressurized, an outer sleeve covering an outer peripheral surface of the inner tube to limit an expansion of the inner tube, the outer sleeve being configured to convert a radial expansion of the inner tube to a longitudinal contraction of the inner tube, wherein

the inner tube is formed of a resilient material having an expansion rate of at least 100%.

As used herein the term “expansion rate” is intended to mean “expansion at prescribed stress Eₛ(%)” calculated in compliance with “JIS K 6251: Rubber, vulcanized or thermoplastics—Determination of tensile stress-strain properties” (see Expression 5 in “15.1 dumbbell-shaped specimen” in the same standard). The specimen used in this test is “dumbbell-shaped specimen No. 1” specified in Table 1 of “6.1 dumbbell shaped specimen” in the same standard. However, the “thickness of a parallel portion” in the same table is 2.5 mm. A tensile force to be applied to the specimen is assumed to be 1.0 kgw.

The actuator of the present disclosure, having the inner tube being formed of a resilient material which is much more elastic than the inner tube used in the McKibben type actuator of the related art (normally it is formed of a resilient material having an expansion rate on the order of several tens % described above), is capable of generating at least the same contraction force as those of the related art with an application of a pressure lower than those required in the related art.

The actuator of the present disclosure, capable of moving without pressurizing the inner tube to a high pressure, is capable of not only lengthening its life time while reducing the probability of breakage of the inner tube, but also achieving downsizing of the inner tube pressurizing means.

Furthermore, the actuator of the present disclosure, having the inner tube formed of a stretchy (soft) material, is capable of preventing a wearer from having too much feeling of constraint when used in a body assisting apparatus.

In the actuator of the present disclosure, the expansion rate of the resilient material that forms the inner tube (hereinafter, may be referred to as “expansion rate of the inner tube”) is not specifically limited as long as it is at least 100%.

However, in order to better achieve the above-described effects, further enhancement of the expansion rate of the inner tube is preferable. The expansion rate of the inner tube is preferably at least 200%, more preferably, at least 300%, more preferably, at least 400%, more preferably, at least 500%, more preferably, at least 600%, more preferably, at least 700%, more preferably, at least 800%, and more preferably, at least 900%. In this manner, the inner tube having a high expansion rate may be formed of, for example, an elastomer foam.

However, too high expansion rates of the inner tube may result in difficulty in maintenance of the strength of the inner tube. Therefore, the expansion rate of the inner tube is normally set not to be higher than 2000%, preferably not to be higher than 1500%.

The actuator of the present disclosure may include a gap between an outer peripheral surface of the inner tube and an inner peripheral surface of the outer sleeve when not pressurized. However, in this case, it may take time from the start of pressurization of the inner tube until the actuator starts a motion. Therefore, the outer peripheral surface of the inner tube is preferably maintained in tight contact with the inner peripheral surface of the outer sleeve when not pressurized. Accordingly, the actuator starts motion immediately after the start of pressurization of the inner tube.

In the McKibben type actuator of the related art, the inner tube and the outer sleeve are fixed to each other at both end portions in the longitudinal direction. The same structure may be employed for the inner tube and the outer sleeve in the actuator of the present disclosure. In the actuator of the present disclosure, when fixing both the end portions of the inner tube in the longitudinal direction and both the end portions of the outer sleeve in the longitudinal direction with each other, the inner tube is preferably kept in an elongated state in the longitudinal direction.

Accordingly, a cylindrical member having a larger outer diameter than the inner diameter of the outer sleeve may be used as an inner tube. The reason is that the more the inner tube is elongated, the more the outer diameter is reduced, and thus the inner tube having an outer diameter larger than the inner diameter of the outer sleeve in a state in a natural length is allowed to be inserted into an interior of the outer sleeve by being elongated.

In a state after the insertion of the inner tube into the outer sleeve, the outer peripheral surface of the inner tube may easily be brought into tight contact with the inner peripheral surface of the outer sleeve. The reason is that the inner tube inserted into the outer sleeve increases in outer diameter by contracting to spring back to the state of its natural length.

In addition, the actuator may easily be contracted immediately after pressurization of the inner tube. The reason is that the contraction of the actuator is achieved by the radial expansion of the inner tube converted into the longitudinal contraction by the outer sleeve, and thus the inner tube immediately after the start of the compression can more easily expand in the radial direction than in the longitudinal direction by keeping the inner tube in a state of being elongated in the longitudinal direction in advance.

In addition, the actuator may be encouraged to contract to assume a compact form when not pressurized. Therefore, the actuator may be suitably used in the body assisting apparatus. For example, as illustrated in FIG. 4(a) and FIG. 4(b), it is assumed that the actuator 10 is used as a body assisting apparatus 100 for the hip. When the configuration of the inner tube fixed to the outer sleeve in a state of being elongated in the longitudinal direction is not employed, the actuator 10 may easily become significantly loosened (see a portion indicated by a phantom portion A in FIG. 4(b)) when a wearer 200 of the body assisting apparatus 100 is seated (when the inner tube is not pressurized). In contrast, when the configuration of the inner tube fixed to the outer sleeve in a state of being elongated in the longitudinal direction is employed, looseness of the actuator 10 when the wearer 200 is seated (when the inner tube is not pressurized) may be alleviated.

In this manner, various effects are achieved when the configuration of the inner tube fixed to the outer sleeve in a state of being elongated in the longitudinal direction is employed. This configuration becomes available by the inner tube formed of a stretchy material. When the inner tube is fixed to the outer sleeve in the state of being elongated in the longitudinal direction in a case where the inner tube is formed of a hardly stretchable (hard) material as in the McKibben type actuator of the related art, a force of the inner tube to spring back to the state in the natural length becomes too strong, and thus the actuator when not pressurized may assume a distorted form. In addition, a significant contraction force is generated in the actuator when not pressurized, and the wearer may have too much feeling of constraint when the actuator is used in the body assisting apparatus.

In addition, the above-described problems may also be solved by providing a body assisting apparatus including:

an actuator of the present disclosure;

an actuator mounting member for mounting the actuator on a predetermined portion of a body; and

inner tube pressurizing means configured to pressurize the inner tube of the actuator.

Accordingly, a body assisting apparatus that the wearer may use comfortably without having too much feeling of constraint may be provided.

In the body assisting apparatus of the present disclosure, the inner tube pressurizing means may be configured to be driven by electric power or the like, but preferably driven manually. Since the actuator of the present disclosure is configured to be moved without pressurizing the inner tube to a high pressure as described above, an operational force sufficient for assisting portions of the body to be assisted may be provided even when a manually driven inner tube pressurizing means is used. Examples of the manually driven inner tube pressurizing means includes a case where an actuator is mounted in a position capable of assisting motion (a motion to pull a thigh forward and upward) of the legs of a wearer, and the inner tube pressurizing means is a foot-operated pump which allows a foot on the opposite side from the foot to be assisted by the actuator to press downward.

As described above, the present disclosure enables an embodiment of a McKibben type actuator capable of generating at least the same contraction force as those of the related art with an application of a pressure lower than those required in the related art. In addition, the McKibben type actuator resistant to breakage of the inner tube and having a long life may also be provided. In addition, a size reduction of a device such as a pump for pressurizing the inner tube (inner tube pressurizing means) in the McKibben type actuator may also be enabled. Still further, the McKibben type actuator providing a high contraction rate and an ability to assist a motion having a significant displacement may also be provided. Furthermore, the McKibben type actuator which prevents a wearer from having too much feeling of constraint when used in a body assisting apparatus may also be provided. Still further, a body assisting apparatus using the actuator of the present disclosure may also be provided.

### BRIEF DESCRIPTION OF THE DRAWINGS

FIG. 1 is a partial cross-section side view illustrating an actuator of the present disclosure;

FIG. 2(a) and FIG. 2(b) are a partial cross-section side view of the actuator in FIG. 1 in a non-pressurized state and in a pressurized state;

FIG. 3 is a drawing illustrating an example of a body assisting apparatus using the actuator of the present disclosure; and

FIG. 4(a) and FIG. 4(b) are an explanatory drawing illustrating a motion of the body assisting apparatus illustrated in FIG. 3.

### DETAILED DESCRIPTION OF THE EMBODIMENTS

1. Actuator of Present Disclosure

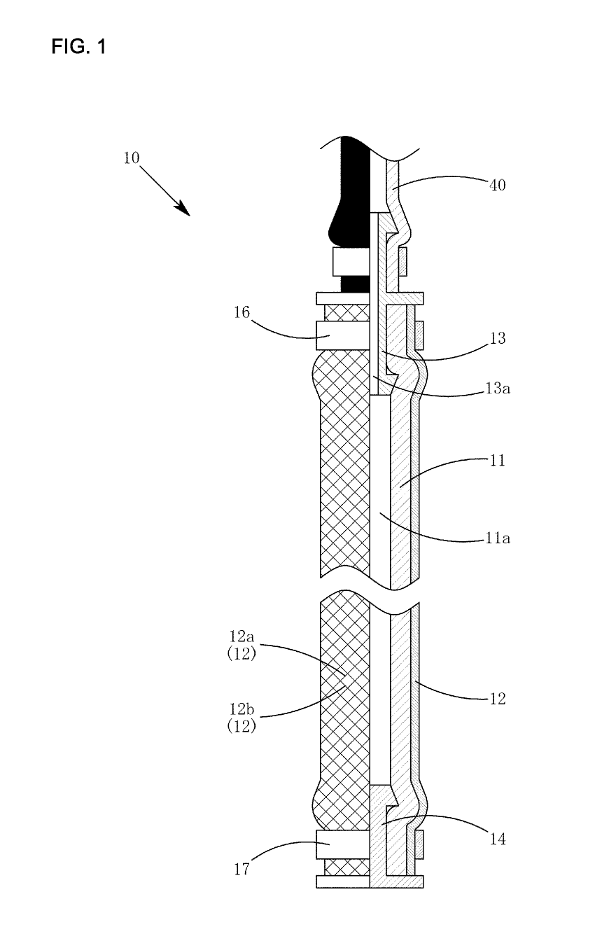

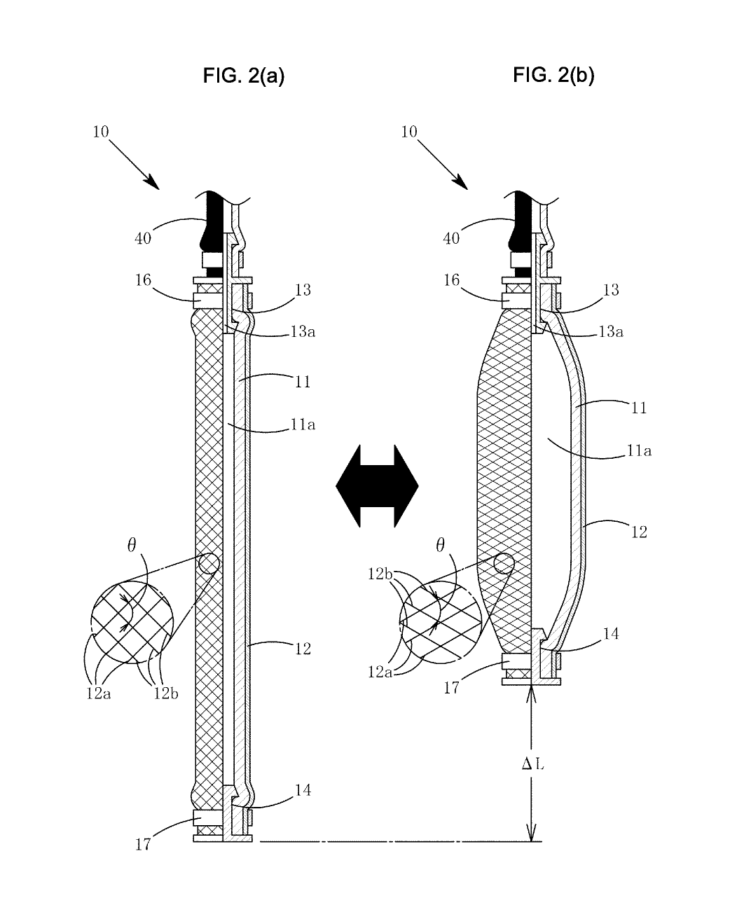

Referring now to the drawings, a preferable embodiment of an actuator of the present disclosure will be described more specifically. FIG. 1 is a partial cross-section side view illustrating an actuator 10 of the present disclosure. FIG. 2(a) and FIG. 2(b) are an explanatory side view in partial cross-section illustrating a motion of the actuator 10 in FIG. 1. FIG. 2(a) illustrates a scene in which an inner tube 11 is in a non-pressurized state, and FIG. 2(b) illustrates a scene in which the inner tube 11 is in a pressurized state. FIG. 1 and FIGS. 2(a)-2(b) illustrate the actuator 10 in cross section on one side with respect to a centerline.

The actuator 10 of the present disclosure is of a McKibben type including the inner tube 11 and an outer sleeve 12 covering the outer peripheral surface of the inner tube 11 as illustrated in FIG. 1. The actuator 10 is configured to assume a thin and long form as illustrated in FIG. 2(a) when the inner tube 11 is not pressurized, and is configured to assume a thick and short form as illustrated in FIG. 2(b) when the inner tube 11 is pressurized.

1.1 Inner Tube

The inner tube 11 is a cylindrical member having a hollow interior as illustrated in FIG. 1. The internal space of the inner tube 11 constitutes a fluid receiving portion 11a for receiving a fluid. Fitted to both end portions (opening ends on both sides) of the inner tube 11 are sealing members 13, 14. The sealing member 13 on one side is provided with a through hole 13a, and one end of the fluid transfer tube 40 is connected thereto. Inner tube pressurizing means, which is not illustrated, is connected to the other end (an end opposite to the end connected to the inner tube 11) of the fluid transfer tube 40. Examples of the inner tube pressurizing means include manually driven pumps and electrically powered pumps. When the inner tube pressurizing means is driven, a fluid is supplied from the inner tube pressurizing means through an interior of the fluid transfer tube 40 and a through hole 13a of the sealing member 13 into the fluid receiving portion 11a of the inner tube 11, whereby the inner tube 11 is pressurized.

The fluid to be supplied to the inner tube 11 may either be a gas or a liquid. However, in a configuration in which a liquid is supplied to the inner tube 11, a tank or the like for storing the liquid is required, which causes a drawback that an apparatus using the actuator 10 may be increased in weight. In addition, a countermeasure for liquid leakage is also required. Therefore, the fluid to be supplied to the inner tube 11 is preferably a gas. In particular, air is preferably supplied. As plenty of air exists around the actuator 10, a tank for storing air is not necessary and in addition, air is harmless even when being exhausted as-is. In an embodiment of the actuator 10, air is supplied to the inner tube 11.

The inner tube 11 is formed of a resilient material. Therefore, when fluid is supplied to the fluid receiving portion 11a and the inner tube 11 is pressurized (when the internal pressure in the inner tube 11 increases), the inner tube 11 starts expanding. As described already, the inner tube 11 in the actuator 10 of the present disclosure is formed of a significantly flexible and stretchy resilient material compared with a resilient material used for the inner tube of the McKibben type actuator of the related art and thus is easily expandable.

The inner tube 11 may be configured to be easily expandable by reducing the thickness of the tube wall. However, when an attempt is made to realize the level of exporsion required for the inner tube 11 in the actuator 10 of the present disclosure with this method, the tube wall of the inner tube 11 may become too thin and may easily be broken. When considering a strength of the inner tube 11, the thickness of the tube wall of the inner tube 11 in the state of its natural length is preferably at least 1 mm, more preferably, at least 1.5 mm, and further preferably, at least 2 mm. In the actuator 10 of the embodiment, the thickness of the tube wall of the inner tube 11 is set to be approximately 2.5 mm. An upper limit of the thickness of the tube wall of the inner tube 11 is not specifically limited, but normally up to approximately 10 to 20 mm when used in a body assisting apparatus described later. In this manner, the tube wall of the inner tube 11 is preferably formed to have a thickness to some extent.

However, when the thickness of the tube wall of the inner tube 11 is increased, enhancement of an expansion rate of the inner tube 11 becomes hard. Therefore, the inner tube 11 is preferably formed of an elastomer foam. Accordingly, the flexibility of the inner tube 11 may be enhanced to a required level while securing the thickness of the tube wall of the inner tube 11. However, when the inner tube 11 is formed of an open-cell foam, the fluid received in the fluid receiving portion 11a may leak outside through the tube wall of the inner tube 11. Therefore, when forming the inner tube 11 with a foam, normally a closed-cell foam is used. Examples of the elastomer used for the inner tube 11 include an elastomer composed of a thermoplastic resin such as polyethylene and an elastomer composed of a thermosetting resin such as a silicone rubber. In the actuator 10 of the embodiment, the inner tube 11 is formed of a polystyrene-based elastomer foam (the closed-cell foam). An expansion rate of the foam is significantly high, and is approximately 927%.

Both end portions of the inner tube 11 in the longitudinal direction are fixed to both end portions of the outer sleeve 12 in the longitudinal direction. A method of fixation between the inner tube 11 and the outer sleeve 12 is not specifically limited. In the actuator 10 of the embodiment, fixing belt 16, 17 are wound around outer peripheral portions of both end portions of the outer sleeve 12 in the longitudinal direction so that both the end portions of the inner tube 11 in the longitudinal direction are fixed to outer peripheral portions of the sealing members 13, 14 together with both the end portions of the outer sleeve 12 in the longitudinal direction. When the inner tube 11 is fixed to the outer sleeve 12, the inner tube 11 is elongated in the longitudinal direction from its natural length. Accordingly, using the cylindrical member having a larger outer diameter than an inner diameter of the outer sleeve 12 as the inner tube 11, bringing the outer peripheral surface of the inner tube 11 in the non-pressurized state into tight contact with the inner peripheral surface of the outer sleeve 12, providing the actuator 10 with a property of being easily contractible from a moment immediately after pressurization of the inner tube 11, and making the actuator 10 when not pressurized tend to contract easily and have a compact form are provided.

How much the inner tube 11 is to be elongated when fixing the inner tube 11 to the outer sleeve 12 is not specifically limited. However, in order to preferably achieve the above-described effects, the inner tube 11 is preferably fixed in a state of being elongated by at least 10% from its natural length. The inner tube 11 is preferably elongated at least 20%, and more preferably, elongated at least 30% from the state of its natural length. In contrast, if the inner tube 11 is elongated too much when being fixed to the outer sleeve 12, the force of the inner tube 11 to spring back to its natural length becomes too strong when the inner tube 11 is in the non-pressurized state, and thus the form of the actuator 10 when not pressurized may become distorted. Therefore, the elongation of the inner tube 11 from its natural length when the inner tube 11 is fixed to the outer sleeve 12 is normally 200% or lower, preferably 100% or lower. In an embodiment of the actuator 10, the inner tube 11 is fixed to the outer sleeve 12 in a state at elongation of approximately 30% of the natural length.

The length and the diameter of the inner tube 11 may vary depending on applications of the actuator 10, and are not specifically limited. Even when the application of the actuator 10 is limited to be used in the body assisting apparatus, dimensions of the actuator 10 may vary depending on the body portions to be assisted. When assisting a motion of a small body portion such as a finger, dimensions of the actuator 10 are set to be small, and when assisting a motion of a large body part such as a leg, the dimensions of the actuator 10 are increased. Assuming usage in the body assisting apparatus, a length of the actuator 10 is on the order of 2 to 3 cm when it is small, and may exceed 100 cm when it is large. The diameter of the actuator 10 may be on the order of 2 to 3 mm when it is small, and may exceed 10 cm when it is large. Dimensions of other members (outer sleeve 12 and so forth) are to be varied corresponding to the inner tube 11.

1.2 Outer Sleeve

The outer sleeve 12 is a cylindrical member covering the outer peripheral surface of the inner tube 11 as illustrated in FIG. 1. The outer sleeve 12 is configured to make the actuator 10 perform a desired motion by limiting the expansion of the inner tube 11. In other words, the outer sleeve 12 functions to contract the actuator 10 by converting a radial expansion of the inner tube 11 into a longitudinal contraction of the same. The specific structure of the outer sleeve 12 is not specifically limited as long as its capable of demonstrating such a function. In an embodiment of the actuator 10, a member formed into a tube shape by weaving a non-expandable first wire 12a and a non-expandable second wire 12b in a crossed state (weaving in a net-like fashion) is used as the outer sleeve 12. An angle of intersection θ between the first wire 12a and the second wire 12b in the outer sleeve 12 varies depending on the shape of the outer sleeve 12 as illustrated in FIG. 2(a) and FIG. 2(b). Therefore, even though the first wire 12a and the second wire 12b are not expandable, the entire outer sleeve 12 may expand and contract by varying the angle of intersection θ between the first wire 12a and the second wire 12b. The outer sleeve 12 is configured to contract in the longitudinal direction when expanding in the radial direction, and contract in the radial direction when elongating in the longitudinal direction.

1.3 Motion of Actuator

A motion of the actuator 10 of the present disclosure will be described. When the inner tube 11 is not pressurized, the actuator 10 assumes a thin and long form as illustrated in FIG. 2(a). When a fluid is supplied to the fluid receiving portion 11a of the inner tube 11 and the inner tube 11 is pressurized from the non-pressurized state, the internal pressure of the fluid receiving portion 11a increases and the inner tube 11 starts expanding. At this time, the inner tube 11 starts expanding mainly in the radial direction. The reason is that an elongated tubular member like the inner tube 11 is considered to have a tendency to expand in the radial direction rather than in the longitudinal direction immediately after the internal pressure starts to increase. In an embodiment of the actuator 10, the inner tube 11 is elongated in advance (the inner tube 11 is fixed to the outer sleeve 12 in an elongated state), and thus the tendency of expanding in the radial direction is further enhanced.

When the inner tube 11 starts expanding in the radial direction, the outer sleeve 12 makes an attempt to expand in the radial direction. However, the outer sleeve 12, being formed of a woven fabric of non-expandable wires (the first wire 12a and the second wire 12b) as described above, can expand in the radial direction only by changing the angle of intersection θ between the first wire 12a and the second wire 12b. Therefore, the outer sleeve 12 contracts in the longitudinal direction while expanding in the radial direction. Therefore, in a state in which the inner tube 11 is pressurized to some extent, the actuator 10 assumes a thick and short form as illustrated in FIG. 2(b). The actuator 10 when pressurized is shorter than the actuator 10 when not pressurized by ΔL (FIGS. 2(a)-2(b)).

In this manner, the actuator 10 of the present disclosure is configured to change form by varying the internal pressure of the inner tube 11. In the actuator 10 of the present disclosure, the inner tube 11 has a very high contraction rate by being formed of a stretchy material. As used herein the term “contraction rate” is intended to include a value calculated by {(L₁−L₂)/L₁}×100, where L₁ is a total length (normally, the maximum value of the length of the actuator 10) of the actuator 10 when not pressurized, and L₂ is a total length (normally, the minimum value of the length of the actuator 10) of the actuator 10 when being pressurized to the maximum. In the McKibben type actuator of the related art, the contraction rate is approximately 25% at the maximum, while the actuator 10 of the present disclosure may have a contraction rate of at least 30%, and further enhancement to at least 35%, or even to at least 40% is possible. The upper limit of the contraction rate of the actuator 10 is not specifically limited, but is normally approximately 50% from a mechanical limitation of the outer sleeve 12.

In the actuator 10 of the present disclosure, a large contraction force may be generated with an application of a low pressure by forming the inner tube 11 of a stretchy material. In other words, in the McKibben type actuator of the related art, for example, the internal pressure of the inner tube 11 needs to be increased to the order of 300 kPa when an attempt is made to obtain a contraction force on the order of 20 N at the time of contraction of 15%, while in the actuator 10 of the present disclosure, the equivalent contraction force may be generated with a pressure on the order of 150 kPa. In an embodiment of the actuator 10 in which the inner tube 11 has an outer diameter of 10 mm, an inner diameter of 5 mm (a thickness of the tube wall is 2.5 mm), and a length of 500 mm, and the inner tube 11 is formed of a resilient material having an expansion rate of 927%, the equivalent contraction force may be generated with a lower pressure (on the order of 90 kPa). Therefore, a compact inner tube pressurizing means described later may be employed.

2. Body Assisting Apparatus of Present Disclosure

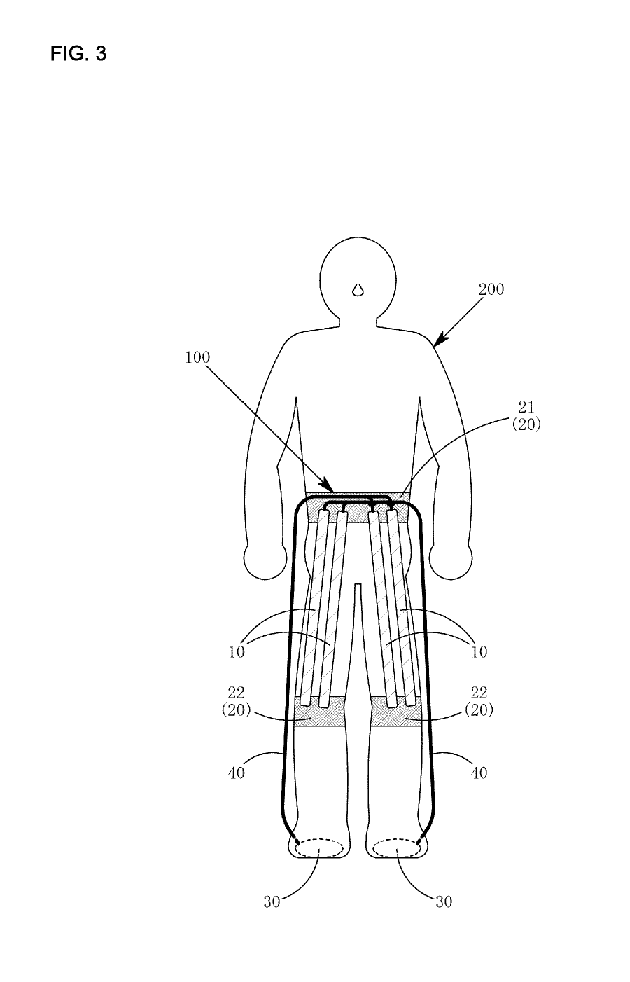

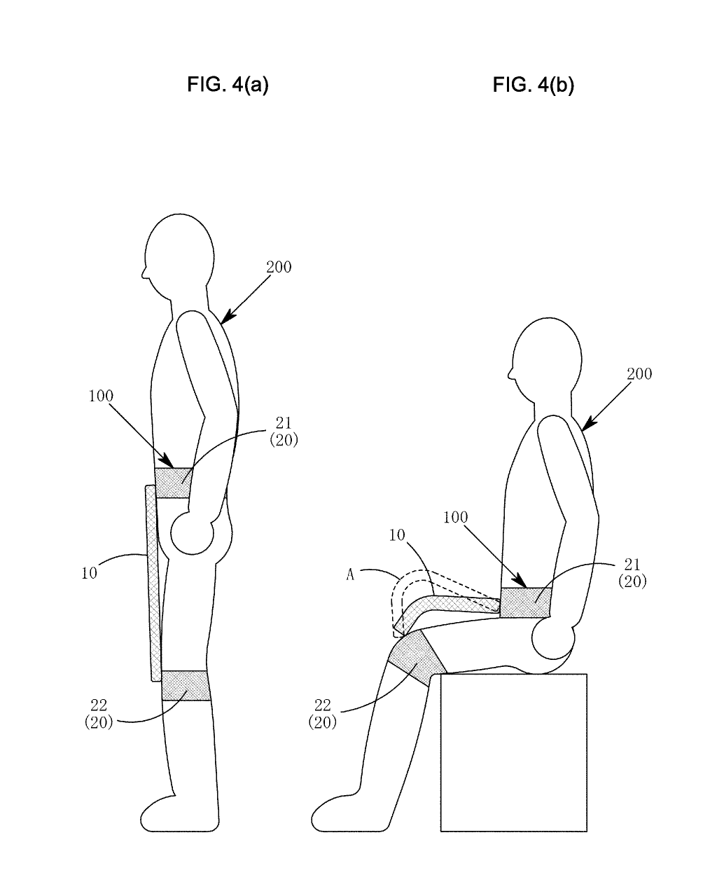

Referring next to the drawings, a preferable embodiment of the body assisting apparatus of the present disclosure will be described more specifically. FIG. 3 is a drawing illustrating an example of a body assisting apparatus 100 using the actuator 10 of the present disclosure. FIG. 4(a) and FIG. 4(b) are an explanatory drawing illustrating the motion of the body assisting apparatus 100 illustrated in FIG. 3. FIG. 4(a) illustrates a scene when a wearer 200 of the body assisting apparatus 100 is standing, and FIG. 4(b) illustrates a scene when the wearer 200 of the body assisting apparatus 100 is seated.

The body assisting apparatus 100 of the present disclosure includes the actuator 10, an actuator mounting member 20 for mounting the actuator 10 on predetermined portions of the body of the wearer 200, and an inner tube pressurizing means 30 for pressurizing the inner tube 11 (FIG. 1) of the actuator 10, as illustrated in FIG. 3. The actuator 10 is of the same McKibben type as that described above (illustrated in FIG. 1). The actuator 10 and the inner tube pressurizing means 30 are connected by the fluid transfer tube 40.

In an embodiment of the body assisting apparatus 100, the actuator mounting member 20 includes a waist mounting member 21 for mounting one end portion (upper end portion) of the actuator 10 on a front side of the waist portion of the wearer 200, and a knee mounting member 22 for mounting the other end portion (lower end portion) of the actuator 10 to a front side of the knee portion of the wearer 200. Therefore, the actuator 10 is disposed on the front side of a thigh of the wearer 200 in the vertical direction. With the actuator 10, a motion of the wearer 200 to pull the thigh forward and upward may be assisted. In an embodiment of the body assisting apparatus 100, two each of the actuators 10 are provided for the left leg and the right leg in parallel.

In an embodiment of the body assisting apparatus 100, the inner tube pressurizing means 30 constitutes a foot-operated pump provided on a sole of the wearer 200. The actuators 10 provided on the left leg are connected to the foot-operated pump 30 for the right foot, and the actuators 10 provided on the right leg are connected to the foot-operated pump 30 for the left leg. Therefore, when the left foot is grounded and thus the foot-operated pump 30 on the sole of the left foot is pushed, the actuators 10 for the right leg are pressurized and thus contract, so that the thigh of the right leg is pulled forward and upward, while when the right foot is grounded and thus the foot-operated pump 30 on the sole of the right foot is pushed, the actuators 10 for the left leg are pressurized and contract, so that the thigh of the left leg is pulled forward and upward. In other word, a walking motion of the wearer 200 is assisted by the body assisting apparatus 100.

When the actuator 10 used in the body assisting apparatus 100 of the present disclosure is capable of generating a significant contraction force with an application of a low pressure as described above. Therefore, in the body assisting apparatus 100 of the present disclosure, the actuator 10 is satisfactorily moved even though the foot-operated pump (the manually driven pumps) is used as the inner tube pressurizing means 30. The body assisting apparatus 100 of the present disclosure, having the inner tube 11 of the actuator 10 being formed of a stretchy and flexible resilient material, allows the wearer 200 to use comfortably without too much constraint. In addition, in an embodiment of the body assisting apparatus 100, the inner tube 11 of the actuator 10 may be fixed to the outer sleeve 12 in the elongated state as described above. Therefore, as illustrated in FIG. 4(b), the extent of looseness of the actuator 10 when the wearer 200 is seated or the like (when the inner tube 11 is not pressurized) may be reduced.

Although the body assisting apparatus of the present disclosure has been described with the example of assisting the motion of the thigh, portions to be assisted by the body assisting apparatus of the present disclosure is not limited thereto. The body assisting apparatus of the present disclosure may be provided in various modes ranging from those assisting motions of relatively small body portions such as fingers, wrists, toes, ankles and so on to those assisting motions of relatively large body portions such as arms, waists, and muscles of the back and so on. In addition, motions of a plurality of body portions and/or a plurality of types of body portions may be assisted with a single body assisting apparatus.

### REFERENCE SIGNS LIST

10 actuator
11 inner tube
11a fluid receiving portion
12 outer sleeve
12a first wire
12b second wire
13 sealing member
13a through hole
14 sealing member
16 fixing belt
17 fixing belt
20 actuator mounting member
21 waist mounting member
22 knee mounting member
30 foot-operated pump (inner tube pressurizing means)
40 fluid transfer tube
100 body assisting apparatus
200 wearer

1. An actuator comprising:
an inner tube configured to be expanded when being pressurized,
an outer sleeve covering an outer peripheral surface of the inner tube to limit an expansion of the inner tube, the outer sleeve being configured to convert a radial expansion of the inner tube to a longitudinal contraction of the inner tube, wherein
the inner tube is formed of a resilient material having an expansion rate of at least 100%.

2. The actuator according to claim 1, wherein the inner tube is formed of a resilient material having an expansion rate of at least 200%.

3. The actuator according to claim 1, wherein the inner tube is formed of an elastomer foam.

4. The actuator according to claim 1, wherein the outer peripheral surface of the inner tube is in tight contact with an inner peripheral surface of the outer sleeve when being not pressurized.

5. The actuator according to claim 1, wherein both end portions of the inner tube in a longitudinal direction are fixed to both end portions of the outer sleeve in the longitudinal direction in a state in which the inner tube is elongated in the longitudinal direction.

6. A body assisting apparatus comprising:
an actuator comprising:
an inner tube configured to be expanded when being pressurized,
an outer sleeve covering an outer peripheral surface of the inner tube to limit an expansion of the inner tube, the outer sleeve being configured to convert a radial expansion of the inner tube to a longitudinal contraction of the inner tube, wherein
the inner tube is formed of a resilient material having an expansion rate of at least 100%;
an actuator mounting member for mounting the actuator on a predetermined portion of a body; and
inner tube pressurizing means configured to pressurize the inner tube of the actuator.

7. The body assisting apparatus according to claim 6, wherein the inner tube pressurizing means is configured to be driven manually.

8. The actuator according to claim 2, wherein the inner tube is formed of an elastomer foam.

9. The actuator according to claim 2, wherein the outer peripheral surface of the inner tube is in tight contact with an inner peripheral surface of the outer sleeve when being not pressurized.

10. The actuator according to claim 3, wherein the outer peripheral surface of the inner tube is in tight contact with an inner peripheral surface of the outer sleeve when being not pressurized.

11. The actuator according to claim 2, wherein both end portions of the inner tube in a longitudinal direction are fixed to both end portions of the outer sleeve in the longitudinal direction in a state in which the inner tube is elongated in the longitudinal direction.

12. The actuator according to claim 3, wherein both end portions of the inner tube in a longitudinal direction are fixed to both end portions of the outer sleeve in the longitudinal direction in a state in which the inner tube is elongated in the longitudinal direction.

13. The actuator according to claim 4, wherein both end portions of the inner tube in a longitudinal direction are fixed to both end portions of the outer sleeve in the longitudinal direction in a state in which the inner tube is elongated in the longitudinal direction.
